(19) United States
(12) Patent Application Publication
(10) Pub. No.: US 2016/0087378 A1
(43) Pub. Date: Mar. 24, 2016

(54) ELECTRICAL SOCKET CONNECTOR

(71) Applicant: BELLWETHER ELECTRONIC CORP., TAOYUAN COUNTY (TW)

(72) Inventors: Kuan-Wu CHEN, TAOYUAN COUNTY (TW); Hsing-Yu LEE, TAOYUAN COUNTY (TW)

(21) Appl. No.: 14/704,220

(22) Filed: May 5, 2015

(30) Foreign Application Priority Data
Sep. 23, 2014 (TW) 103216835

(51) Int. Cl. H01R 13/6597; H01R 12/71

(52) U.S. Cl. CPC H01R 13/6597; H01R 12/716

(57) ABSTRACT

An electrical socket connector includes an insulating base, a metal casing, a metal partition plate and plural signal terminals. The insulating base includes a tongue, a metal casing sheathed on insulating base and disposed around the tongue, and the metal partition plate is embedded in the tongue. At least one grounding terminal is extended from the metal partition plate. The signal terminals are embedded in the insulating base and partitioned on both sides of the corresponding metal partition plate respectively. The grounding terminal is extended and passed out of the insulating base and in contact with the metal casing to achieve the grounding effect.

### FIELD OF THE INVENTION

The present invention relates to an electrical connector, and more particularly to an electrical socket connector grounded by its metal casing.

### BACKGROUND OF THE INVENTION

Electrical connector is applied extensively in mobile electronic devices and used for the purpose of electrical charge or data transmission. As the mobile electronic devices tend to be developed with a light and thin design, the electrical connector needs to reduce its volume correspondingly. In addition, the circuit board of the mobile electronic device comes with an area for soldering an electrical connector, and such area needs to be reduced according to the light and thin design of the mobile electronic device, and pins for power supply, signal transmission and grounding must be soldered in the limited space. Therefore, an effective way of utilizing the limited soldering space becomes an important issue to the design of electrical connectors.

In view of the aforementioned problems of the prior art, the inventor of the present invention invented the present invention to overcome the problems of the prior art.

### SUMMARY OF THE INVENTION

Therefore, it is a primary objective of the present invention to provide an electrical socket connector that is grounded by its metal casing, and the electrical socket connector is soldered onto a circuit board and provided for plugging a corresponding electrical plug connector.

To achieve the aforementioned and other objectives, the present invention provides an electrical socket connector, comprising an insulating base, a metal casing, a metal partition plate and a plurality of signal terminals. The insulating base includes a tongue, a metal casing sheathed on the insulating base and disposed around the tongue, and the metal partition plate is embedded in the tongue. At least one grounding terminal is extended from the metal partition plate and then passed out of the insulating base, and finally in contact with the metal casing. The signal terminal is embedded in the insulating base and partitioned and disposed on both sides of the metal partition plate respectively.

Preferably, an end of each signal terminal is exposed from the tongue. Both ends of each signal terminal are a soldering end and a connecting end respectively, and the soldering end is extended and passed out of the insulating base, and the connecting ends are exposed from the tongue and arranged into two rows and parallel to one another, and the two rows of the connecting ends are disposed on both sides of the tongue respectively. The metal partition plate is partitioned between the two rows of the connecting ends, and at least one hook is extended from the metal partition plate and protruded from a side edge of the tongue. An end of the grounding terminal is preferably in the shape of an inverted hook.

The metal casing preferably includes a cylindrical body, and both ends of the cylindrical body are an open end and a closed end respectively, and the open end is disposed around the tongue, and a cover plate is extended from the closed end for covering the closed end. The grounding terminal may touch the cover plate or the cylindrical body. The grounding terminals may be extended in opposite directions and configured to be back to back with respect to each other or extended in the same direction.

Since the grounding terminal of the electrical socket connector of the present invention is in contact with the metal casing, therefore it is not necessary to solder the grounding terminal to the circuit board to achieve the grounding effect.

### BRIEF DESCRIPTION OF THE DRAWINGS

FIG. 1 is an exploded view of an electrical socket connector in accordance with a first preferred embodiment of the present invention;

FIG. 2 is a perspective view of an electrical socket connector in accordance with the first preferred embodiment of the present invention;

FIG. 3 is a schematic view of an electrical socket connector in accordance with the first preferred embodiment of the present invention;

FIG. 4 is another schematic view of an electrical socket connector in accordance with the first preferred embodiment of the present invention;

FIG. 5 is a cross-sectional view of an electrical socket connector in accordance with the first preferred embodiment of the present invention;

FIG. 6 is an exploded view of an electrical socket connector in accordance with a second preferred embodiment of the present invention;

FIG. 7 is a schematic view of an electrical socket connector in accordance with the second preferred embodiment of the present invention;

FIG. 8 is a cross-sectional view of an electrical socket connector in accordance with the second preferred embodiment of the present invention;

FIG. 9 is an exploded view of an electrical socket connector in accordance with a third preferred embodiment of the present invention;

FIG. 10 is a schematic view of an electrical socket connector in accordance with the third preferred embodiment of the present invention; and

FIG. 11 is a cross-sectional view of an electrical socket connector in accordance with the third preferred embodiment of the present invention.

### DESCRIPTION OF THE PREFERRED EMBODIMENTS

The technical contents of the present invention will become apparent with the detailed description of preferred embodiments accompanied with the illustration of related drawings as follows.

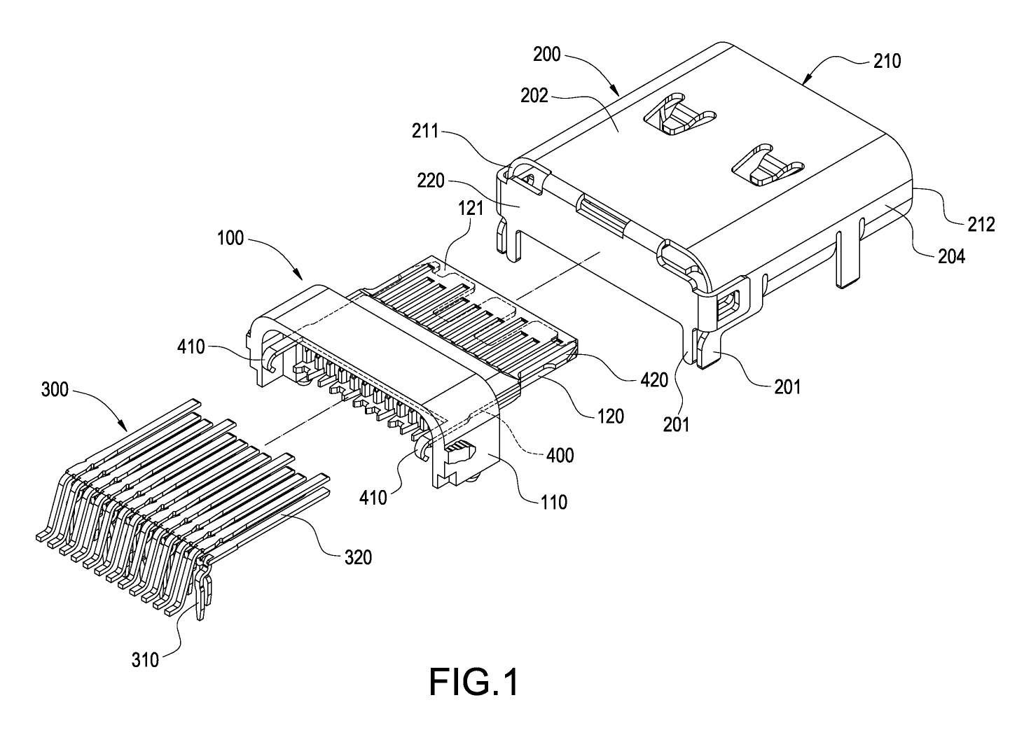

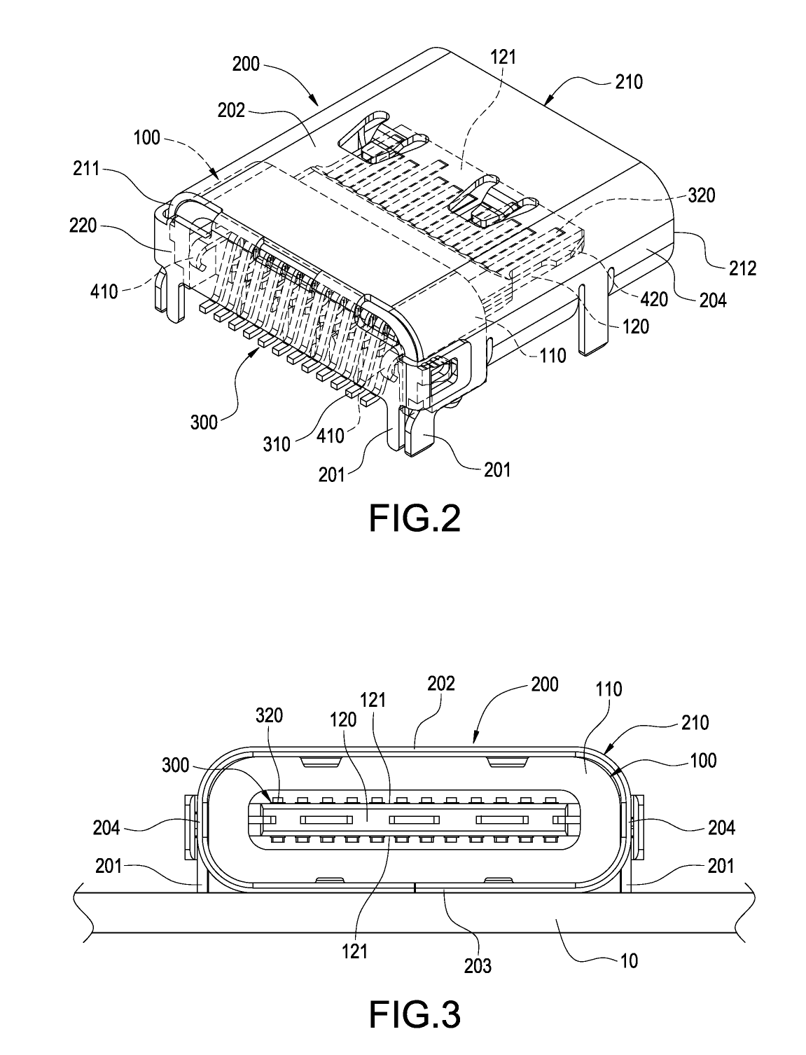

With reference to FIGS. 1 and 2 for an electrical socket connector in accordance with the first preferred embodiment of the present invention, the electrical socket connector comprises an insulating base 100, a metal casing 200, a plurality of signal terminals 300 and a metal partition plate 400.

In this preferred embodiment, the insulating base 100 is preferably made of plastic and includes a main body 110 and a tongue 120 extended from the main body, wherein both sides of the tongue 120 form two connecting sides 121 configured to be back to back with respect to each other for plugging an electrical plug connector.

The metal casing 200 includes a cylindrical body 210, a cover plate 220, and a plurality of pins 201 extended from the cylindrical body 210 and the cover plate 220 respectively, but the quantity and installation position of the pins 201 of the present invention are not limited specifically. The cylindrical body 210 is preferably formed by bending a metal plate and provided for plugging the electrical plug connector, wherein the cylindrical body 210 comes with a rectangular cross-section and has a top plate 202 and a bottom plate 203 disposed opposite to each other, and two side plates 204 are installed between the top plate 202 and the bottom plate 203. Both ends of the cylindrical body 210 are a closed end 211 and an open end 212 respectively, and the closed end 211 is sheathed on the main body 110 of the insulating base 100, and the open end 212 is disposed around the tongue 120, and the cover plate 220 is extended from the closed end 211, and the cover plate 220 covers the closed end 211.

Each signal terminal 300 is a long-strip metal plate, and both ends of each signal terminal 300 are a soldering end 310 and a connecting end 320, wherein the soldering end 310 is extended and passed out of the main body 110 of the insulating base 100, and the connecting end 320 is exposed from the tongue 120. In this preferred embodiment, the connecting ends 320 are preferably arranged into two rows and parallel to one another, and the two rows of connecting ends 320 are exposed from each connecting side 121, and the two rows of connecting ends 320 preferably have the same arrangement for electrically connecting the electrical plug connector.

The metal partition plate 400 is embedded in the tongue 120 and partitioned between the two rows of connecting ends 320. Two grounding terminals 410 are extended from two side edges of the metal partition plate 400 respectively and the pair of grounding terminals 410 are preferably extended in the same direction. The pair of grounding terminals 410 are extended and passed out of the main body 110, and an end of each grounding terminal 410 is substantially in the shape of an inverted hook, and the end of each grounding terminal 410 is contacted with the cover plate 220 and electrically coupled to the metal casing 200. A hook 420 is extended separately from the other pair of side edges of the metal partition plate 400, and the pair of hooks 420 are extended in opposite directions and configured to be back to back with respect to each other, and protruded from a side edge of the tongue 120 for latching the electrical plug connector.

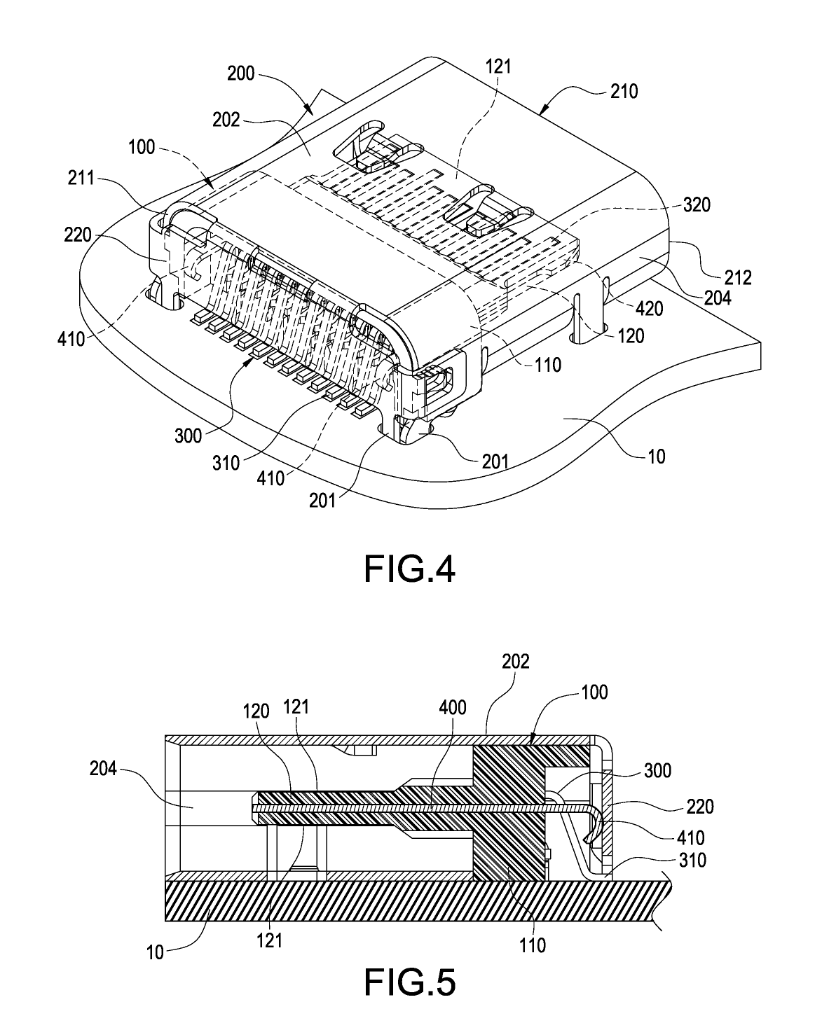

With reference to FIGS. 3 to 5 for an electrical socket connector of the present invention, the electrical socket connector is installed on a circuit board 10, and each pin of the metal casing 200 is soldered onto the circuit board 10, such that the electrical socket connector of the present invention is fixed onto the circuit board 10. The soldering end 310 of each signal terminal 300 is soldered to the circuit board 10 and electrically coupled to the circuit board 10. Each grounding terminal 410 is electrically coupled to the circuit board 10 through the metal casing 200 without requiring the process of soldering to the circuit board 10, and thus the space for soldering the signal terminal 300 on the circuit board 10 will not be occupied.

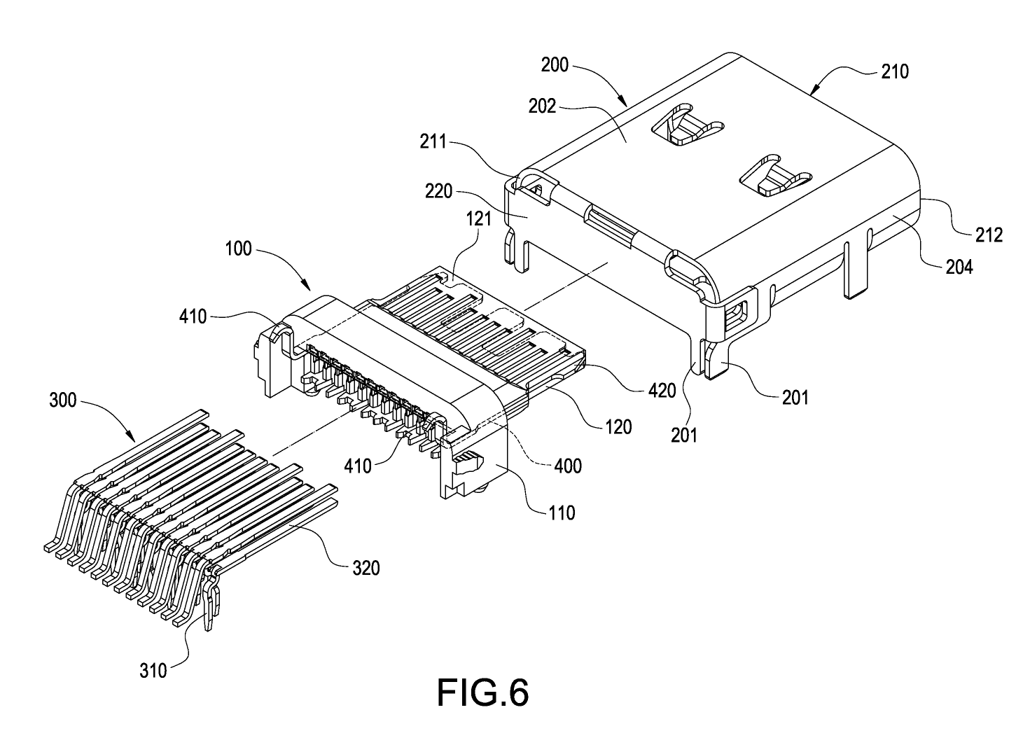

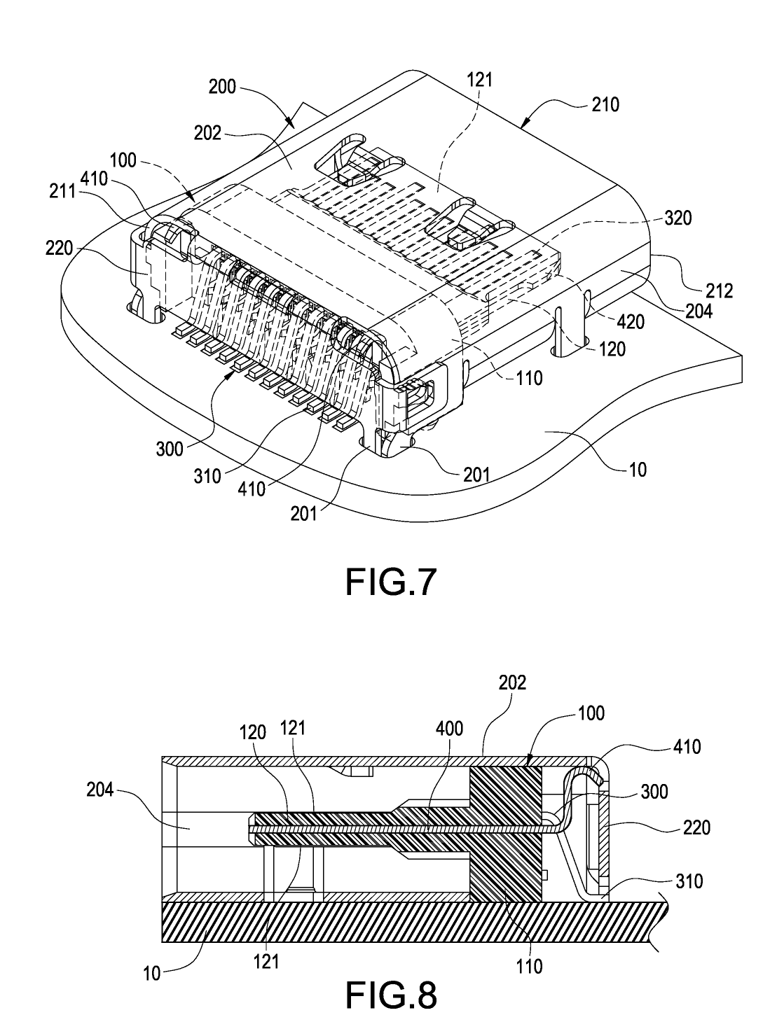

With reference to FIGS. 6 to 8 for an electrical socket connector in accordance with the second preferred embodiment of the present invention, the electrical socket connector comprises an insulating base 100, a metal casing 200, a plurality of signal terminals 300 and a metal partition plate 400, and the structure of these components is substantially the same as those described in the first preferred embodiment, and thus are not repeated, and only the difference from the first preferred embodiment will be described below.

In this preferred embodiment, two grounding terminals 410 are extended from the metal partition plate 400, and the pair of grounding terminals 410 are extended in the same direction, and the end of each grounding terminal 410 is substantially in the shape of an inverted hook and contacted with the inner side of the top plate 202 of the cylindrical body 210 and electrically coupled to the metal casing 200.

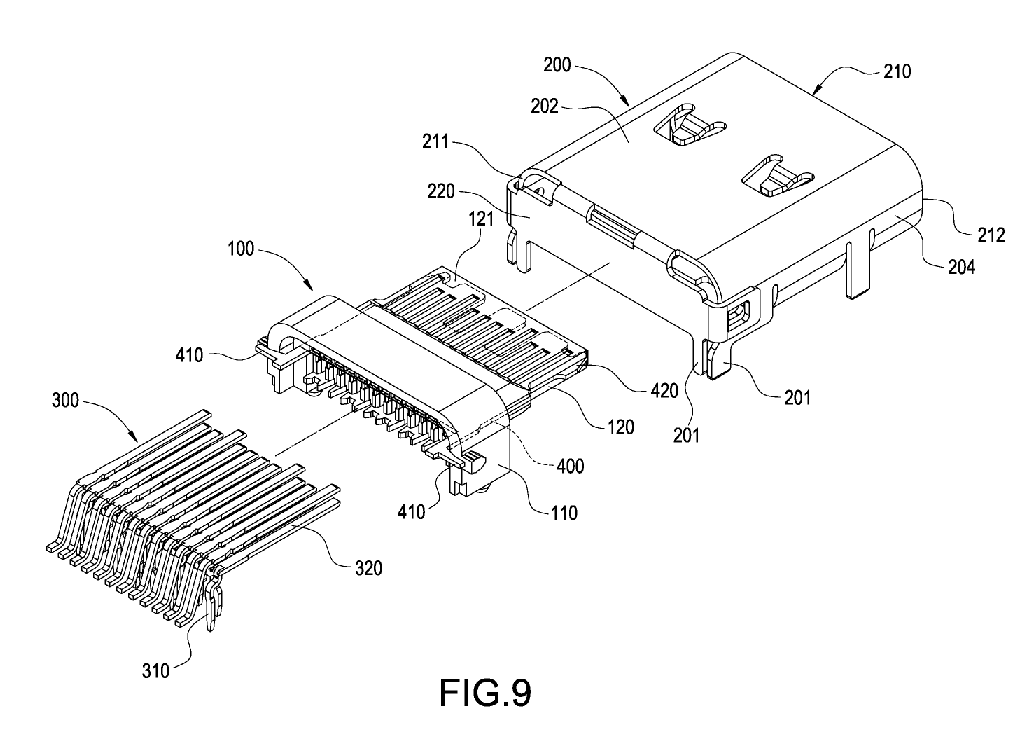

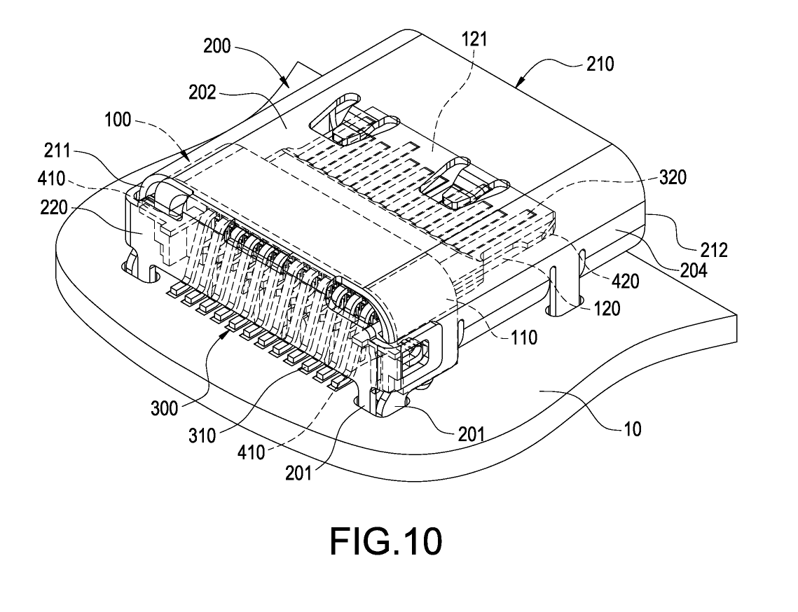

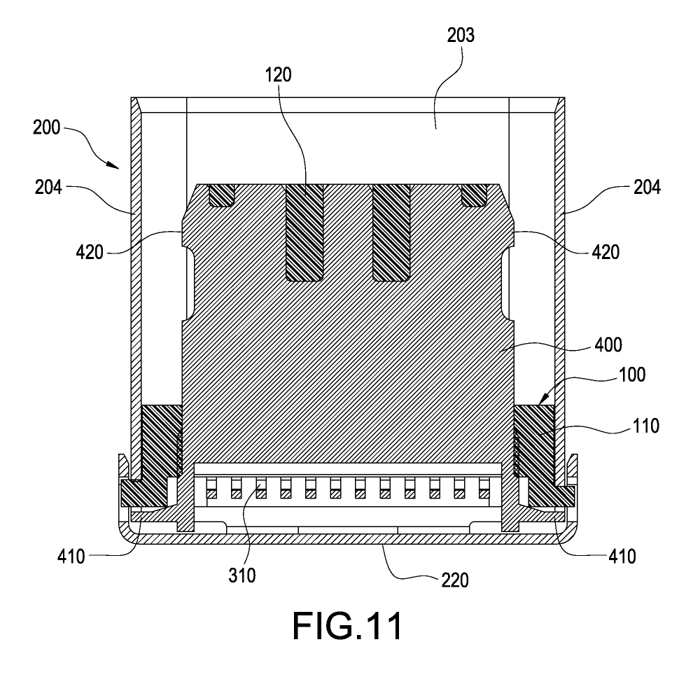

With reference to FIGS. 9 to 11 for an electrical socket connector in accordance with the third preferred embodiment of the present invention, the electrical socket connector comprises an insulating base 100, a metal casing 200, a plurality of signal terminals 300 and a metal partition plate 400, and the structure of these components is substantially the same as those described in the first preferred embodiment, and thus are not repeated, and only the difference from the first preferred embodiment will be described below.

In this preferred embodiment, two grounding terminals 410 are extended from the metal partition plate 400, and the ends of each grounding terminal 410 are bent and extended, and the ends of the pair of the grounding terminals 410 are extended in opposite direction and configured to be back to back with respect to each other and contacted with the inner side of each side plate 204 of the cylindrical body 210 and electrically coupled to the metal casing 200.

While the invention has been described by means of specific embodiments, numerous modifications and variations could be made thereto by those skilled in the art without departing from the scope and spirit of the invention set forth in the claims.

What is claimed is:

1. An electrical socket connector, comprising:
an insulating base, including a tongue;
a metal casing, sheathed on the insulating base, and installed around the tongue;
a metal partition plate, embedded in the tongue, and having at least one grounding terminal extended outwardly from the metal partition plate, and the grounding terminal being extended and passed out of the insulating base and in contact with the metal casing; and
a plurality of signal terminals, embedded into the insulating base, and configured to be apart and corresponsive to both sides of the metal partition plate.

2. The electrical socket connector as claimed in claim 1, wherein each signal terminal has an end exposed from the tongue.

3. The electrical socket connector as claimed in claim 2, wherein each signal terminal has both ends which are a soldering end and a connecting end, and the soldering end is extended and passed out of the insulating base, and the connecting ends are exposed from the tongue, and the connecting ends are arranged into two rows and parallel to one another, and the two rows of connecting ends are disposed on two sides of the tongue respectively.

4. The electrical socket connector as claimed in claim 3, wherein the metal partition plate is partitioned between the two rows of the connecting ends.

5. The electrical socket connector as claimed in claim 1, wherein the metal partition plate has at least one hook extended therefrom, and the hook is protruded out of a side edge of the tongue.

6. The electrical socket connector as claimed in claim 1, wherein the grounding terminal has an end substantially in the shape of an inverted hook.

7. The electrical socket connector as claimed in claim 1, wherein the metal casing includes a cylindrical body, and both ends of the cylindrical body are an open end and a closed end respectively, and the open end is disposed around the tongue, and the closed end has a cover plate extended therefrom, and the cover plate covers the closed end, and the grounding terminal touches the cover plate.

8. The electrical socket connector as claimed in claim 1, wherein the metal casing includes a cylindrical body, and the grounding terminal touches the cylindrical body.

9. The electrical socket connector as claimed in claim 1, wherein the metal partition plate has two grounding terminals extended therefrom, and the pair of grounding terminals are extended in opposite directions and configured to be back to back with respect to each other.

10. The electrical socket connector as claimed in claim 1, wherein the metal partition plate has two grounding terminals extended therefrom, and the pair of grounding terminals are extended in the same direction.
